(19) United States
(12) Patent Application Publication
(10) Pub. No.: US 2012/0213939 A1
(43) Pub. Date: Aug. 23, 2012

(54) Enhanced Electro And Electroless Plating Method And The Plating Thereof

(75) Inventors: Kim Wee TAN, Singapore (SG); Sien Ruey WONG, Singapore (SG)

(73) Assignee: Inspiraz Technology Pte Ltd, Singapore (SG)

(21) Appl. No.: 13/371,482

(22) Filed: Feb. 13, 2012

(30) Foreign Application Priority Data
Feb. 22, 2011 (SG) 201101245-7

(51) Int. Cl. B05D 1/18; C09D 5/00; C25D 15/00; C01B 31/00; B82Y 30/00

(52) U.S. Cl. 427/430.1; 205/109; 423/446; 106/472; 106/1.05; 977/773

(57) ABSTRACT

The present invention provides an enhanced plating for electro and electroless plating. There is provided a method of plating a surface to be plated, the method comprises premixing a plating solution with additive. The additive comprises diamond particles is also provided.

### FIELD OF THE INVENTION

The present invention relates to enhanced plating process. In particular, the invention relates to a plating process applicable for electro and electroless plating and a method thereof.

### BACKGROUND

Surface furnishing processes on metallic surfaces are commonly required for improving corrosion resistance, electrical performance, wear resistance, hardness, cosmetic and etc. These surface furnishing processes include electroplating or electroless-plating for depositing or coating a layer of material onto the surface of the metallic substrate to achieve the same. The electroplating and electroless-plating is applicable on wide range of applications.

In the field of reliability, functionality and burn-in test for semiconductor industry, for example, interconnects such as test sockets are used as a medium for transmitting data signals from test boards to test devices, vice versa. The interconnects include test sockets that uses test pins or spring probe, such as pogo pins or stamp pins, with low electrical resistance to transmit data at any frequency without changing or losing the integrity of the transmitted data signal. Such pogo pins or stamp pins are subjected to replacement due to mechanical wear and tear, increased in contact resistance, high contamination of material migration, etc.

Gold has good resistance to oxidative corrosion, excellent electrical conductivity, and is chemically least reactive. Therefore, it is typically preferred for depositing onto test pins as surface finishing through electroplating or electroless-plating process. When hard solder, also known as lead-free solder, were introduced and used in the industrial, the durability and lifespan of such test sockets were affected. As gold is a ductile pure metal, it cannot withstand repeating wear rate in hard lead-free solder or material migration in soft lead-free solder when subjected to high multiple compressions and cycles in reliability, functionality and burn-in testings for semiconductors.

It is known that alternative metal alloy plating, Palladium Cobalt, can increase the durability and lifespan by approximately 30% because of its increased hardness properties resulting in lower wear rate. However using this alternative, the electrical conductivity drops by approximately 20˜40%. This compromises the integrity of the transmitted data signal but allows more durability and longer lifespan.

### SUMMARY

The present invention provides an enhanced electro and electroless plating method and a plating thereof. In one aspect of the present invention, there is provided a method of plating a surface to be plated. The method comprises premixing a plating solution with additive comprising diamond particles. Such plating method is applicable for electroplating and electroless-plating.

In one embodiment, the additive particles may comprise nano-size diamond particles or micro-size diamond particles. It is possible that the the additive particles is a postmix comprising the diamond particles and water. Desirably, the diamond particles are doped and suspended in the plating solution the diamond particles are randomly distributed evenly in the plating solution. The additive can be added into any plating solution.

In a further embodiment, the additive comprises about 0.1˜5.0 wt % of diamond particles and about 95.0˜99.9 wt % of the plating solution. More specifically, the additive comprises about 0.25˜2.5 wt % of diamond particles and about 97.5˜99.75 wt % of plating solution.

In another aspect of the present invention, there is provided an additive for use in the aforesaid method.

### BRIEF DESCRIPTION OF THE DRAWINGS

This invention will be described by way of non-limiting embodiments of the present invention, with reference to the accompanying drawing, in which:

FIG. 1 exemplifies a typical plating process flowchart with options of adding enhancement additives in different process points;

FIG. 2 illustrates a cross sectional view of a plated test pin in accordance with one embodiment of the present invention;

FIG. 3 exemplifies the accelerated wear resistance comparison chart on different weight-percentage of pre-mixing additive into the plating solutions;

### DETAILED DESCRIPTION

In line with the above summary, the following description of a number of specific and alternative embodiments are provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

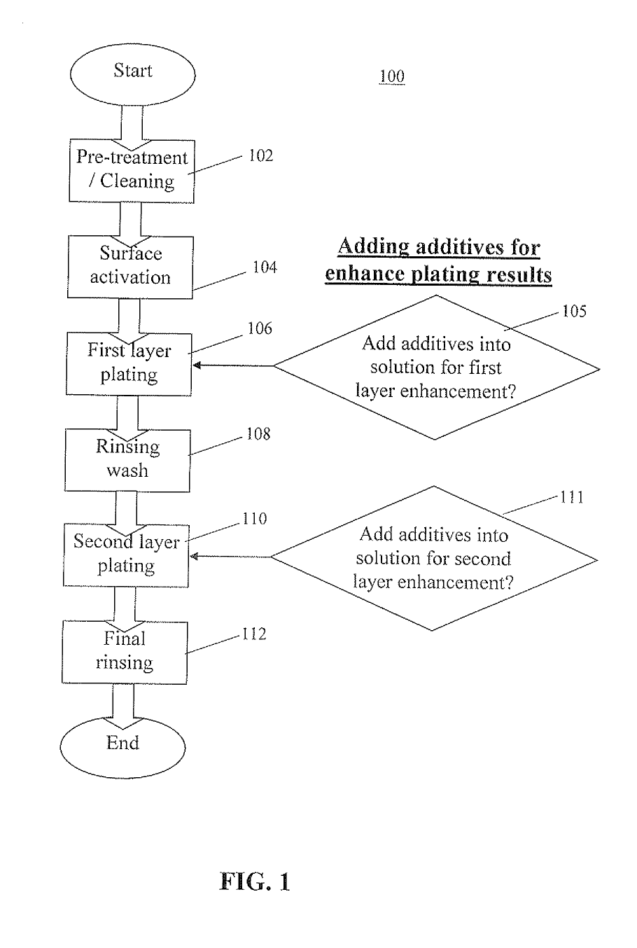

FIG. 1 illustrates a flow diagram of a plating process 100 in accordance with one embodiment of the present invention. In this plating process 100, it is desired to provide two plating layer onto a surface to be plated. The plating process 100 comprises pre-treating the surface to be plated at step 102; activating the surface to be plated at step 104; pre-mixing additive into a first plating solution at step 105; plating a first plating layer on the surface at step 106; rinsing the plated surface at step 108; pre-mixing additive into a second plating solution at step 111; plating a second plating layer on the plated surface at step 110; and rinsing the plated surface at step 112.

At the step 106, the first plating layer is a nickel plating. Prior to the first layer plating process, the first plating solution is pre-mixed with an additive at step 105. The additive comprises diamond particles. It is desired that when the first plating solution is pre-mixed with the additive, the diamond particles are dispersed and suspended in the first plating solution. More preferably, the diamond particles are dispersed and suspended evenly in the first plating solution.

At the step 110, the second plating layer is gold plating. Prior to the second layer plating process, the second plating solution is pre-mixed with an additive at step 111. The additive comprises diamond particles. It is desired that when the second plating solution is pre-mixed with the additive, the diamond particles are dispersed and suspended in the second plating solution. More preferably, the diamond particles are dispersed and suspended evenly in the second plating solution.

Alternative metal alloy plating, Palladium Cobalt used on test pins in the semiconductor industrial, can be pre-mixed with the additive prior to the plating process. The additive comprises diamond particles. It is desired that when the Palladium Cobalt plating solution is pre-mixed with the additive, the diamond particles are dispersed and suspended in the plating solution. More preferably, the diamond particles are dispersed and suspended evenly in the solution.

In accordance with one embodiment of the present invention, the additive may pre-mixed with the respective plating solution at a prescribed amount. More specifically, the plating solution is added with a prescribed amount of diamond particles. Preferably, the diamond particles are micro-size or pulverized particles. More preferably, the diamond particles are nano-size particles for a relatively larger surface area. With the added diamond particles, the metal plating is being enhanced in durability and lifespan with minimal compromises in electrical conductivity.

In an alternative embodiment, the additive may be prepared in a form of postmix comprising the aforesaid diamond particles and liquid. As mentioned, the diamond particles can be in micro-sized or nano-sized particles. The liquid, preferably, the liquid is a neutral solution, such as water. Further the postmix can be in a desired diamond concentration that is adapted for mixing with the plating solution. In accordance with the present invention, the postmix can be added to the plating solution prior to any plating process to obtain similar properties on the final product and not limited to the flow diagram as illustrated in FIG. 1. Preferably, the postmix may be doped and suspended in the plating solutions as the additive and further being adhered onto the plated surface together with its existing required plating. This flexibility application allows modification and enhanced improvement to many available plating solutions. With these enhanced improvement properties, plating thickness and time may be reduced in obtaining the same results without using the present invention.

In a further embodiment, the diamond particles are doped and suspended into any existing chemicals used for plating and coating. The diamond particles may comprise about 0.1˜5.0 wt % of diamond particles and about 95.0˜99.9 wt % of the plating chemical. However the effective and preferred doping ranges between about 0.25˜2.5 wt % of diamond particles to 97.5˜99.75 wt % of plating solution.

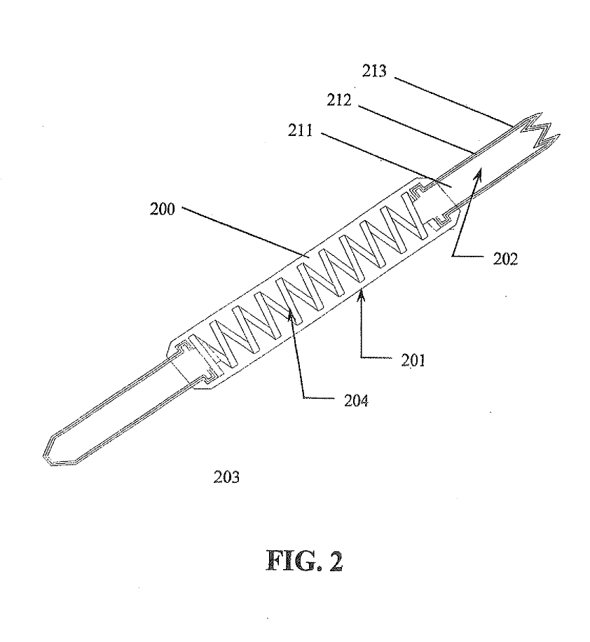

FIG. 2 illustrates a cross section view of a plated test pin 200 in accordance with one embodiment of the present invention. The plated test pin 200 comprises a barrel 201, holding a top plunger 202 and a bottom plunger 203, and a spring 204 within the barrel 201 to allow the movements on both top plunger 202 and bottom plunger 203. Operationally, data/signals are transmitted through the top plunger 202, the barrel 201, the spring 204 and the bottom plunger 203. Typically, a layer of nickel followed by gold are plated on all parts of the test pins to improve their electrical conductivity. The nickel plating 212 increases the original material hardness and provides a better adhesion and binding for the final gold plating 213 to be applied thereon. The gold plating 213 on the other hand improves the electrical conductivity.

Still referring to FIG. 2, diamond particles are doped and suspended in the plating solution. Diamond particles have two major properties namely high hardness and low co-efficient of friction. The suspended diamond particles are then being transferred onto the individual parts of the test pin 200 such as the barrel 201, the top plunger 202 and the bottom plunger 203 during the manufacturing process through electro or electroless plating. This allows the diamond particles to adhere onto the individual parts of the test pin 200 in random microscopic distribution coverage. The increased hardness from the diamond particles improves the wear resistance on the individual parts of the test pin 200 during high multiple compressions and cycles. The low co-efficient of friction in diamond particles reduces the migration rate between the 2 contacting surfaces. These two major properties in diamond particles improves the wear resistance rate by 30˜600% for the same plated thickness as compared without the presents of the diamond particles.

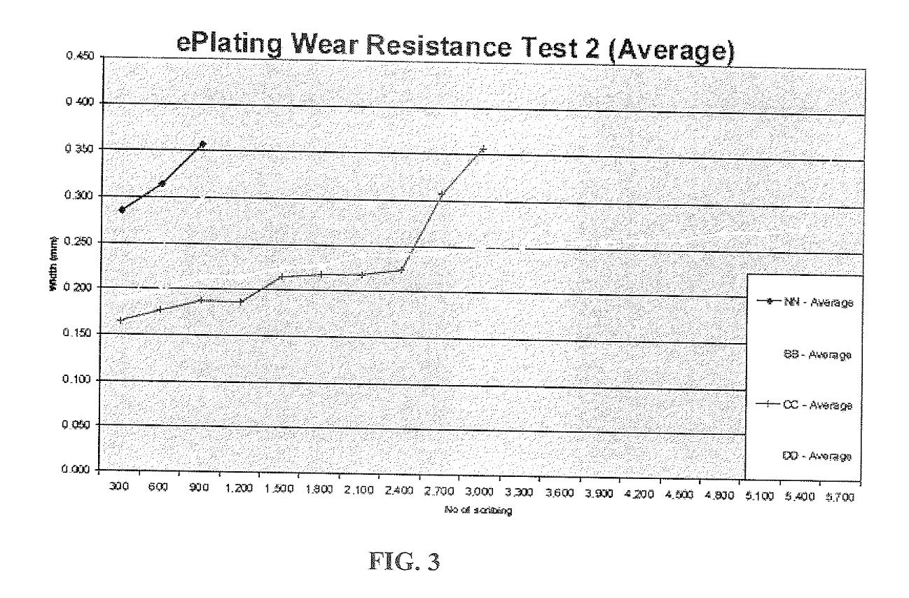

FIG. 3 shows a chart comparing a durability of the plated surfaces with various percentages of the diamond particles thereon. The comparison chart is taken from an accelerated scrubbing wear resistance test. Such test is carried out on the flat copper clad and subjected individually to the same known consistent spring plunger acting onto each individual plated surface for number of cycles until it reaches a scratch width of above about 0.35 mm.

The curve NN represents the copper clad with normal plating, i.e. without additional diamond particles. The curve BB represents the copper clad with 1.0 wt % of diamond particles added. The curve CC represents the copper clad with 1.5 wt % diamond particles added. The curve DD represents the copper clad with 2.0 wt % diamond. In this test, the diamonds used in the plating are nano-size diamond particles.

As shown in FIG. 3, the wear resistance increases by about three time for CC (plated with 1.5 wt % diamond particles) and up to about six times for DD (plated with 2.0 wt % diamond particles).

The present invention is targeted on wide usage applications requiring high wear resistance with presence of low co-efficient of friction. Some other examples of such applications are ball bearing parts, movable parts/components used in clean rooms, USB contact tips, flash/solid-state cards contact tips, earpiece connectors/connectors to charger used in mobile phones/devices and even jewelleries like wedding rings or necklaces. These application examples are possible as the present invention enhanced the plating qualities with the presence of both low co-efficient of friction to reduce contaminations and also increased wear resistance to provide a harder surface properties.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

1. A method of plating a surface to be plated comprising premixing a plating solution with additive comprising diamond particles.

2. The method according to claim 1, wherein the plating method is electroplating.

3. The method according to claim 1, wherein the plating method is electroless-plating.

4. The method according to claim 1, wherein the additive particles comprises nano-size diamond particles.

5. The method according to claim 1, wherein the additive particles comprises micro-size diamond particles.

6. The method according to claim 1, wherein the additive particles is postmix comprising the diamond particles and water.

7. The method according to claim 1, wherein the diamond particles are doped and suspended in the plating solution.

8. The method according to claim 7, wherein the diamond particles are randomly distributed evenly in the plating solution.

9. The method according to claim 1, wherein the additive can he added into any plating solution.

10. The method according to claim 1, wherein the additive comprises about 0.1 5.0 wt % of diamond particles and about 95.0˜99.9 wt % of the plating solution.

11. The method according to claim 1, wherein the additive comprises about 0.25 2.5 wt % of diamond particles and about 97.5˜99.75 wt % of plating solution.

12. An additive for use in claim 1.

13. An additive for use in claim 4.

14. An additive for use in claim 5.

15. An additive for use in claim 6.

16. An additive for use in claim 7.

17. An additive for use in claim 8.

18. An additive for use in claim 10.

19. An additive for use in claim 11.
